(19) United States
(12) Patent Application Publication
(10) Pub. No.: US 2008/0148308 A1
(43) Pub. Date: Jun. 19, 2008

(54) In-Channel Marketing and Product Testing System

(76) Inventors: Larry James Hughes, Cincinnati, OH (US); Chang Gao, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 12/034,851

(22) Filed: Feb. 21, 2008

Related U.S. Application Data
(62) Division of application No. 09/874,853, filed on Jun. 5, 2001.
(60) Provisional application No. 60/290,131, filed on May 10, 2001.

(51) Int. Cl. H04H 60/33

(52) U.S. Cl. 725/10

(57) ABSTRACT

An in-channel marketing and product testing system having a purchase environment module with instructions for generating a virtual purchase environment comprising a plurality of competitive products. The system also includes a panelist interface configured to receive panelist input, wherein the panelist interface is arranged in selective communication with the purchase environment module to receive and display the virtual purchase environment. The system might also have a research module in communication with the purchase environment module and the panelist interface. The research module is configured to enable selective control and manipulation of the virtual purchase environment generation and to receive panelist input from the panelist interface to facilitate analysis of test data and preferences.

### CROSS REFERENCE TO RELATED APPLICATION

This application is a divisional of application Ser. No. 09/874,853, filed Jun. 5, 2001, which claims the benefit of U.S. Provisional Application Ser. No. 60/290,131, filed May 10, 2001.

### FIELD OF THE INVENTION

The present invention relates to an in-channel marketing and product testing system, and, more particularly, to a system and method of providing an in-channel marketing and product testing system designed to facilitate testing of factors that influence in-channel consumer behaviors and decisions.

### BACKGROUND OF THE INVENTION

Consumer product manufacturing companies make decisions everyday regarding characteristics of products manufactured and sold to consumers. More particularly, these same companies typically must address a plurality of issues when desiring to introduce a new product to market or to re-introduce a re-invented product. For example, introducing a new product to market generally requires a company to know at what price to offer a product, where to locate their product with respect to related products and/or competitors' products, how much shelf space to purchase and how to package the particular product. The answers to these and other questions are often times illusive due to a lack of knowledge or a lack of data relating to the product sought to be introduced to market.

Nonetheless, a number of traditional test marketing methods have been established to help companies address these issues. For example, in one approach, a company may design, develop and prototype a product and establish a test market in a particular city or geographic location to determine whether consumers will purchase the product. Another traditional approach might be to create an actual physical test facility at a central location, which mimics an actual store, such as a grocery store to determine whether a consumer would purchase the product as it might appear in the store. Another approach may be to conduct telephone interviews or mail interviews, whereby a picture of a product is mailed to a consumer, and in a follow up call the consumer may be asked a series of questions about the product such as whether they would purchase the product if they saw it in a store. It is through these traditional marketing methodologies that researchers attempt to predict whether consumers will try or repurchase a particular product.

While these methods can provide a realistic prediction of a new product's acceptance among consumers, each method suffers from a variety of negative limitations and consequences. For example, designing, developing and prototyping a particular product is relatively expensive, and purchase related testing generally requires an actual product to be in existence at the time of providing an actual physical test. This limits a manufacturer's ability to test a plurality of concept designs or packagings. Similarly, while mail and telephone interview techniques may not require an actual product to be in existence, this methodology is typically insufficient because it does not test the acceptance of a product in a holistic shopping environment. For example, a consumer may look at a picture of a product and believe they would purchase the product if it were in stores. However, upon actually seeing the product, or after having an opportunity to comparison shop, the consumer may change his or her mind. As used herein, the term holistic is contemplated to mean a shopping environment that simulates an actual, physical shopping experience.

In view of these limitations, it would be advantageous to provide a system and method that would allow a company to test a new product or re-invented product without incurring the limitations associated with traditional test marketing approaches. A virtual in-channel marketing and product testing system, is one such solution. For example, a virtual in-channel marketing and product testing system might generate and transmit a visual display of a holistic shopping environment. A consumer having access to the system might be allowed to virtually shop in the environment, and the consumer's interactions with the system could be analyzed to predict a products potential acceptance in the marketplace. As used herein, the term in-channel is contemplated to mean any location or environment where a consumer could procure or sample a product.

From a research standpoint, a virtual in-channel marketing and product testing system might provide numerous advantages over any of the traditional approaches. For example, test marketing a product is not limited to any specific geographic location or any specific physical environment. In fact, a virtual in-channel market could be programmed to simulate any real or fictitious store located in any geography, anywhere in the world. Other advantages may include that any characteristic of a virtual in-channel market environment could easily be dynamically modified or manipulated in real-time by programming the desired changes. Moreover, multiple tests could be run simultaneously to allow, for example, a company to virtually test multiple concept designs or packagings without actually prototyping each particular product.

A virtual in-channel marketing and product testing system might also provide numerous advantages to consumer panelists versus traditional test marketing approaches. Most notably, consumer panelists might no longer have to physically participate at a central physical location at a specific time. Rather, consumer panelists could participate in a test marketing exercise at any time they desire and from the convenience of their own home provided they have access to the Internet. Moreover, because a test might be conducted in a holistic environment, consumers would not be burdened by having to “guess” whether they would purchase a product without having an opportunity to comparison shop versus brands they currently purchase.

### SUMMARY OF THE INVENTION

In an exemplary embodiment of the present invention, an in-channel marketing and product testing system comprises a purchase environment module having instructions for generating a virtual purchase environment comprising a plurality of competitive products. The system also includes a panelist interface configured to receive panelist input, wherein the panelist interface is arranged in selective communication with the purchase environment module and configured to receive and display the virtual purchase environment. The system may further comprise a research module in communication with the panelist interface. The research module is configured to enable selective control and manipulation of the virtual purchase environment generation and to receive panelist input from the panelist interface.

In another embodiment of the present invention, an in-channel marketing and product testing system comprises a purchase environment module having instructions for generating a virtual purchase environment comprising a plurality of competitive products. The system also comprises a panelist interface configured to receive panelist input and configured to receive and display the virtual purchase environment. The system might also include a fulfillment module configured to receive purchase orders from a panelist and a research module in communication with the panelist interface. The research module is configured to enable selective control and manipulation of the virtual purchase environment generation and to receive panelist input from the panelist interface to facilitate analysis thereof.

Yet another non-limiting embodiment of the present invention is a method of providing an in-channel marketing and product testing system. The method includes providing a purchase environment module having instructions for generating a virtual purchase environment comprising a plurality of competitive products. Next, the method provides a panelist interface configured to receive panelist input. The panelist interface is arranged in selective communication with the purchase environment module to receive and display the virtual purchase environment. A virtual purchase environment is then displayed to at least one panelist in communication with the panelist interface and the panelist's interactions are collected through input into the panelist interface. Lastly, a research module is provided in communication with the purchase environment module and the panelist interface to collect the panelist input from the panelist interface to facilitate analysis thereof.

Yet another embodiment of the present invention is a method of collecting data relating to an identifiable characteristic of a product. The method comprises the steps of providing a purchase environment module having instructions for generating a virtual purchase environment. Next, a panelist interface is provided to receive panelist input and is configured to receive and display the virtual purchase environment. At least one question is then provided to a panelist relating to an identifiable characteristic of a product, and an answer to the question is received through the panelist interface. A virtual purchase environment is generated and displayed based at least in part on the answer to a question. A panelist's interactions with the virtual purchase environment are subsequently collected and a research module is provided in communication the panelist interface to receive the panelist input relating to the panelists interaction with the system.

In yet another embodiment of the present invention, a computer-readable medium is provided, which contains instructions for controlling a computer system to provide an in-channel marketing and product testing system. The computer readable medium generates a signal for transmitting a virtual purchase environment comprising a plurality of competitive products. Next, the transmission signal is provided to a panelist interface, which is configured to receive panelist input. The panelist interface is configured to receive and display the virtual purchase environment. A virtual purchase environment is then displayed to at least one panelist in communication with the panelist interface and the panelist's interactions are collected through input into the panelist interface. A research module is also provided to collect the panelist input from the panelist interface.

Yet another embodiment of the present invention is a method in a computer system for providing an in-channel marketing and product testing system. The method comprises the steps of providing a purchase environment module having instructions for generating a virtual purchase environment comprising a plurality of competitive products. Next, a panelist interface is provided, which is configured to receive panelist input. The panelist interface is arranged in selective communication with the purchase environment module to receive and display the virtual purchase environment. A virtual purchase environment is then displayed to at least one panelist in communication with the panelist interface and the panelist's interactions are collected through input into the panelist interface. A research module is also provided in communication with the purchase environment module and the panelist interface to collect the panelist input from the panelist interface to facilitate analysis thereof.

Yet another embodiment of the present invention is a method of using a panelist interface for accessing an in-channel marketing and product testing system. The method comprises the steps of providing a panelist an identification record and allowing a panelist in communication with said panelist interface to access the system via user input comprising the identification record. Next, a virtual purchase environment is displayed to the panelist in communication with the panelist interface and the panelist's interactions with the virtual purchase environment are collected through input into the panelist interface in communication with a research module and configured to receive the panelists input to facilitate analysis thereof.

Finally, in yet another non-limiting embodiment of the present invention, a computer-readable medium containing a data structure for an in-channel marketing and product testing system is provided. The computer readable medium is provided with a purchase environment module having instructions for generating a virtual purchase environment comprising a plurality of competitive products. The virtual purchase environment being capable of being manipulated in real-time. The medium is also provided with a panelist interface configured to receive panelist input, wherein the panelist interface is arranged in selective communication with the purchase environment module to receive and display the virtual purchase environment. A virtual purchase environment is then displayed to at least one panelist in communication with the panelist interface and the panelist's interactions are collected through input into the panelist interface. A research module is also provided in communication with the purchase environment module and the panelist interface to collect the panelist input from the panelist interface to facilitate analysis thereof.

Still other objects, advantages and novel features of the present invention will become apparent to those skilled in the art from the following detailed description, which is simply, by way of illustration, various modes contemplated for carrying out the invention. As will be realized, the invention is capable of other different obvious aspects all without departing from the invention. Accordingly, the drawings and descriptions are illustrative in nature and not restrictive.

### BRIEF DESCRIPTION OF THE DRAWINGS

While the specification concludes with claims particularly pointing out and distinctly claiming the present invention, it is believed that the same will be understood from the following description taken in conjunction with the accompanying drawings in which:

FIG. 1 is a schematic illustration of an in-channel marketing and product testing system in accordance with the present invention;

FIG. 2 is a non-limiting embodiment of a virtual purchase environment as generated by an in-channel marketing and product testing system of the present invention;

FIG. 3 is a schematic illustration of another embodiment of an in-channel marketing and product testing system in accordance with the present invention;

FIG. 4 depicts a flow diagram of a method of implementing in-channel marketing and product testing system according to the present invention;

FIG. 5 depicts a non-limiting embodiment of a virtual purchase environment as generated by an in-channel marketing and product testing system;

FIG. 6 depicts a screen shot of exemplary embodiment of a virtual purchase environment as generated by an in-channel marketing and product testing system;

FIG. 7 depicts a screen shot of exemplary embodiment of a virtual purchase environment as generated by an in-channel marketing and product testing system;

FIG. 8 depicts a screen shot of exemplary embodiment of a virtual purchase environment as generated by an in-channel marketing and product testing system;

FIG. 9 depicts a schematic illustration of an exemplary network system of the present invention; and

FIG. 10 depicts an alternative schematic illustration of an exemplary network system of the present invention.

### DETAILED DESCRIPTION OF EXEMPLARY EMBODIMENTS

Reference will now be made in detail to various embodiments of the invention, various examples of which are illustrated in the accompanying drawings, wherein like numerals indicate corresponding elements throughout the views.

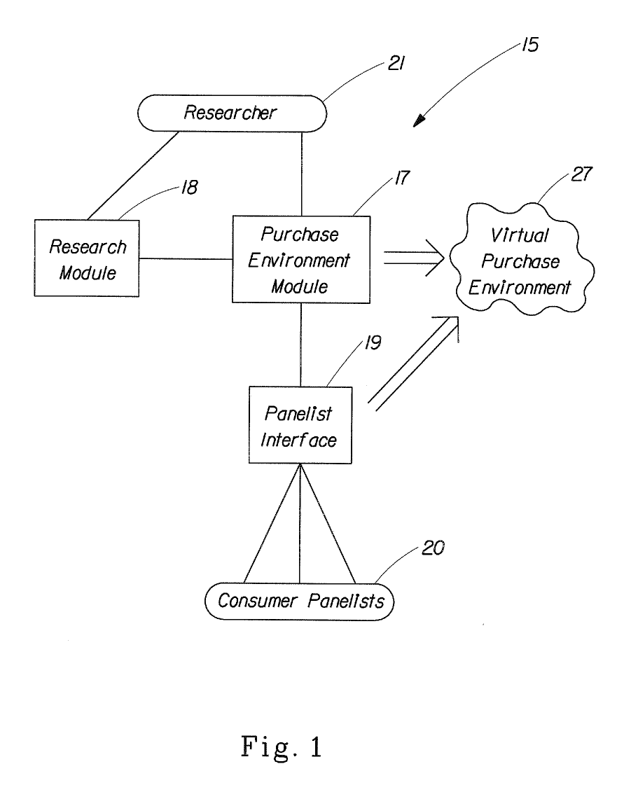

A non-limiting embodiment of the present invention is schematically illustrated in FIG. 1, which depicts an in-channel marketing and product testing system 15, generally designed to facilitate testing of factors that influence in-channel consumer behaviors and decisions such as whether a consumer might purchase or repurchase a particular product. In general, and as will be more fully discussed in detail, an in-channel marketing and product testing system 15 might generate and electronically transmit a visual display of a virtual purchase environment 27 to a panelist interface 19 accessible by at least one consumer panelist 20. A virtual purchase environment 27 generated by a purchase environment module 17 might provide an in-channel shopping environment for a consumer panelist or group of panelists to conduct a shopping exercise. The interactions of a consumer panelist 20 with a system 15 while shopping within a virtual purchase environment 27 might be collected as data to be analyzed by a researcher 21 to generally study the shopping habits of consumer panelists to predict consumer acceptance or reaction to a particular product or characteristic of a product.

The purpose of a marketing and product testing system 15 is to learn more about the factors that influence in-channel consumer behaviors and decisions relating to consumer products. A system 15 might be used to measure the willingness of consumers to purchase or repurchase a particular product, to measure the impact of exposure to coupons, signs, banners or advertisements, or to predict product acceptance by geography or by a particular store location. More particularly, it is contemplated that an in-channel marketing and product testing system 15 might allow a manufacturer to determine the likelihood of success of taking a new product to market. For example, an in-channel testing system 15 might allow a manufacturer to test the elasticity of demand of a product based on changes to an identifiable characteristic of the product such as price, packaging, location of the product on a store shelf or arrangement with respect to competitors' products. The system 15 could also be used by a manufacturer to forecast the volume of a product expected to be sold or to forecast market share gain or loss when a product or competitors' product is brought to market. It should be recognized that the above examples are only a small portion of the numerous applications of the present invention that will subsequently be described.

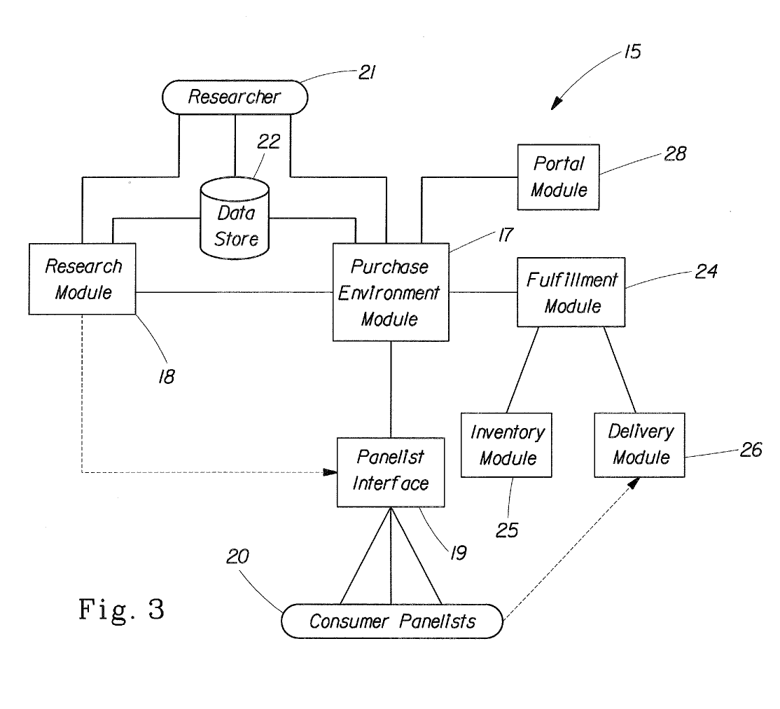

In general, it should be recognized that a system 15, as depicted in FIGS. 1 and 3 could comprise a single integral set of executable instructions, such as in the form of software, routines, programs, algorithms, code and the like. On the other hand, portions of these executable instructions could be handled by several components of a system working in parallel, serial or combinations thereof. For simplicity of discussion, the system 15 is illustrated by separate components such as a purchase environment module 17, a research module 18 and a panelist interface 19 as illustrated in FIG. 1, wherein each component might likely comprise a set of executable instructions or the like. It is contemplated that the components of a system 15 could be provided on a single system or multiple systems in various parts of the world to allow access to the system 15 at any time and from anywhere in the world. Moreover, each component of a system 15 might be provided in communication with each of the other components, such as via a token ring, Ethernet, telephone modem connection, radio or microwave connection, parallel cables, serial cables, telephone lines, universal serial bus “USB”, Firewire, Bluetooth, fiber optics, infrared “IR”, radio frequency “RF” and the like, or combinations thereof.

It is further contemplated that in an exemplary embodiment of the present invention an in-channel marketing and product testing system 15 might be operated through a web-site hosted on a network such as a wide-area network, local-area network, or the Internet. Such an embodiment might provide numerous advantages for consumer panelists 20 over traditional test marketing approaches, such as, for example, consumer panelists might no longer have to physically participate at a central facility at a specific time. Consumer panelists could participate in a test marketing exercise at any time they desire and from the convenience of their own home provided they have access to the Internet.

In a non-limiting embodiment of the invention, as contemplated in FIG. 1, and as discussed herein, a system 15 might be accessible by at least one consumer panelist 20. It is contemplated that a consumer panelist 20 would be an individual willing to participate in an interactive shopping exercise for the purpose of allowing a researcher 21 to learn more about the factors that influence a consumer's in-channel shopping behavior and purchase decisions. Consumer panelists 20 are typically volunteers who agree to participate in an interactive shopping exercise with the system 15 in exchange for some type of reward, such as free merchandise, coupons, and the like. While a panelist is interacting with a system 15, the panelist interactions might be collected as data so that a researcher 21, upon analysis, can learn more about the shopping habits of consumers when purchasing consumer products.

An in-channel marketing and product testing system 15, might comprise a panelist interface 19 to allow a consumer panelist 20 to communicate with the system 15. Although it should be recognized that a panelist interface could be in communication with any component of a system 15, in an exemplary embodiment of the invention, a panelist interface 19 might be in selective communication with a purchase environment module 17. It is contemplated that a system 15 might be capable of simultaneously interfacing with a plurality of panelist's interfaces 19 at any time and that panelist interfaces 19 might be located remotely from each other and might be located remotely from any component of a system 15. In other words, a panelist interface might be located on site with the system, or might be located in a home of a panelist. In an alternate embodiment, the system 15 might comprise a panelist interface module configured to receive panelist input from a panelist interface. The panelist interface module might be arranged in selective communication with a purchase environment module and configured to receive and display a virtual purchase environment. Once again, it should be recognized that the functions of the panelist interface module could be provided by any component of the system, but in an exemplary embodiment, a panelist interface communicates directly with a purchase environment module.

In an exemplary embodiment of the invention, a panelist interface 19 might comprise a kiosk, computer, personal digital assistant (PDA), a device with wireless application programs (WAP) such as cell phone, auto computer, interactive TV, an Internet appliance, or other access device. In one relatively common exemplary embodiment, a panelist interface 19 may comprise a computer system having a CPU, memory, a visual display device and a keyboard or other input device such as a mouse or joystick Additionally, a panelist interface 19 might comprise an Internet connection through a communication link and running a web browser such as Internet Explorer from Microsoft Corp. or Netscape Navigator from Netscape Communications Corp.

It is further contemplated, as depicted in FIG. 1, that an in-channel marketing and product testing system comprise a purchase environment module 17, which among other things, might be programmed to generate a virtual purchase environment 27 for display to at least one consumer panelist 20. In one embodiment of the invention, a purchase environment module 17 might generate and electronically transmit a visual display of a virtual purchase environment 27 to a panelist interface 19. In its simplest form, a purchase environment module 17 might display a virtual purchase environment 27 that comprises a display of one product, or even one fictitious product. Similarly, a virtual purchase environment 27 might display a single shelf comprising a specific category of products, or might be expanded to display multiple shelves having multiple categories of products. It should be recognized that a virtual purchase environment 27 could be a simulation of any shopping environment contemplated by a researcher 21, or by a consumer product manufacturing company.

As will be more fully discussed, a virtual purchase environment 27 might be programmed to display a virtual reality, three-dimensional or two-dimensional simulation of a real or fictitious store. In more detail, a virtual purchase environment could be programmed to display an actual physical store located anywhere in the world, or, could more specifically simulate a specific store, such as a Walmart, K-mart, Target, or any other store in any location or in any geography, anywhere in the world. Additionally, it should be recognized that a virtual purchase environment 27 could be programmed to simulate a grocery store, bodega, warehouse, flee market, e-tail, or any other purchase environment or location. Additionally, it should be recognized that virtual images of the virtual purchase environment 27 could be digitally scanned or otherwise programmed and stored in a system 15, but in an exemplary embodiment of the invention, the virtual images are stored having an image data format such as JPG, TIF, GIF or other well known data format.

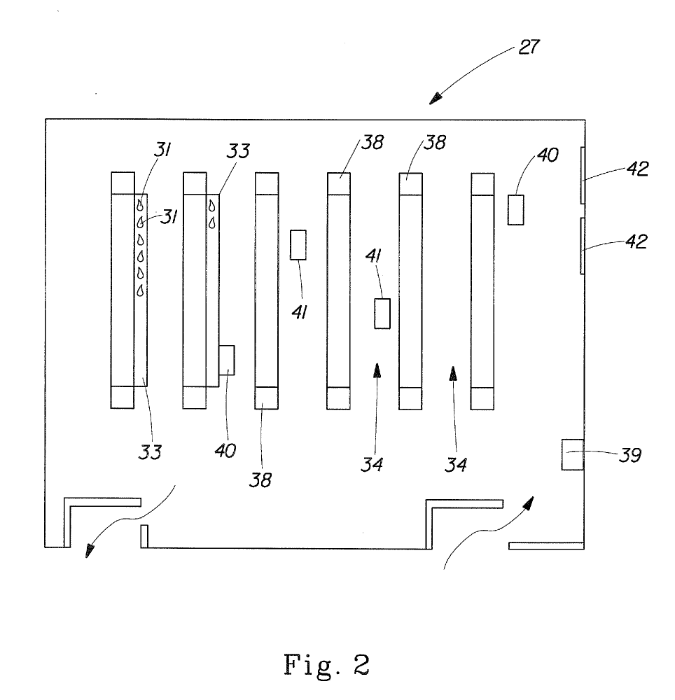

In an exemplary embodiment of the invention, however, a purchase environment module 17 generates a holistic virtual purchase environment 27. The purpose of providing a holistic environment is to emulate the psychology of an actual shopping experience. For example, as depicted in FIG. 2, it is contemplated that a virtual holistic purchase environment 27 might be programmed to display virtual images that comprise a simulation of a store having aisles 34, end-caps 38 or mid-aisle displays 41, shelves 33 comprising a plurality of competitive products 31, signage or banners 42, in-store coupons 39, demonstration stations such as televisions 40, sounds such as background noise, overhead speaker announcements, a radio, and the like. It is contemplated that a virtual depiction of a demonstration station 40 may comprise a video display of a sales person or demonstrator showing a particular product or playing an advertisement for a particular product. Additionally, advertisements for a particular product might be played as panelists shop such as via a simulated radio situated on a shelf or through a simulated overhead speaker, or advertisements could be displayed on banners or in-store coupon books or the like. In other alternative embodiments, it should be recognized that other sources of media may also be available such a virtual depiction of a personal computer displaying an advertisement, or a telephone playing an advertisement, a depiction of a marketing or sales brochure or the like.

Additionally, it should be recognized that as technology advances, a virtual holistic store could further be provided with a plurality of other sensory stimulating elements such as smells or scents associated with a particular aisle in a grocery store, such as a laundry aisle. It might also be possible to provide other stimulus such as tactile simulation through a “glove” for allowing a panelist to pick-up or feel the weight of a product or to feel the texture of a product. It should be recognized that a virtual store such as that depicted in FIG. 2. is not limited to these features, but, rather may comprise virtually any arrangement of these and other features that may be found in a physical store.

As further illustrated in FIG. 1, it is contemplated that an in-channel marketing and product testing system 15 might comprise a research module 18. Although a research module 18 could be an integral or separate component of a system 15, in an exemplary embodiment of the invention, a research module 18 might be, among other things, in selective communication with a purchase environment module 17. A research module 18 might be provided with tools that allow a researcher 21 to selectively control and manipulate the generation of a virtual purchase environment 27. It should be recognized that a research module and a purchase environment module might be separate or integral components of a system 15, and that the tools provided could be located in either, or both, of the modules or in any other component of the system 15. As used herein, the term tools is contemplated to mean executable instructions, such as in the form of software, routines, program, code and the like, which allow a virtual purchase environment to be dynamically manipulated at any time, including real-time. Additionally, in its broadest sense, the term dynamically is contemplated to mean that the system 15 is flexible and that the system 15 is configured to allow a virtual purchase environment to be modified over some minimal period of time, where in some instances, it may take several minutes to dynamically manipulate a virtual purchase environment and in other instances it may take several hours. In other words, the system 15 is capable of being modified before a shopping exercise, while a shopping exercise is being conducted, between shopping exercises, after a shopping exercise, or at any other time.

In a non-limiting embodiment of the present invention, it is contemplated that a researcher 21 might be able to virtually rearrange any feature associated with a virtual purchase environment. For example, a virtual purchase environment could be programmed or re-programmed to rearrange a display of a product location on a shelf or within an aisle using programming tools accessible through the system 15 such as tools provided in a research module. A researcher 21 may also be able to virtually change the display of a price of a product, its description, its packaging, advertisements or banners, aisle markers and their descriptions, and what products are located in each aisle and on each shelf. For example, if a consumer product manufacturing company plans to introduce a new product to market, the company may desire to run multiple tests to determine the price at which the product should be sold or to predict which packaging option presents the highest likelihood of product acceptance among consumers. In more advanced studies, a manufacturer could use a system 15 to forecast market demand or predict sales volume for a product, to forecast market share of a product or to determine if a product's introduction will capture market share from a competitor's product or an already existing product offer through the manufacturer.

Moreover, it is contemplated that the tools might be accessible by more than one researcher 21, where multiple researchers are located in different geographies or different locations. In an exemplary embodiment of the present invention, a researcher or group of researchers might have the capability, through any component of a system 15, such as a purchase environment module 17, to generate any desired virtual purchase environment 27 and, furthermore, have the capability to selectively manipulate any display within the environment 27 via programming tools provided for within the system 15 such as in a research module 18. For example, by utilizing tools in a research module 18, a researcher 21, might be able to re-program and manipulate the display of a virtual purchase environment such as changing the price of a product or the arrangement of a product on a shelf or within an aisle.

In an exemplary embodiment of the invention, a research module 18 might also be in selective communication with a panelist interface 19. A research module 18 might receive input from a panelist interface 19 for facilitating research relating to a panelist's interactions while shopping within a virtual purchase environment 27. As used herein, the term interactions is contemplated to mean the “clicks” of a mouse or other input that a panelist 20 uses to interface with a system 15 such as a panelist's manipulation and/or purchase of a particular product. In other words, a research module 18 might be configured to record every keystroke, mouse click or other panelist input while a panelist is participating in an interactive shopping exercise with the system 15. As a result, a research module 18 provides a researcher 21 with data in the form of panelists' interactions to learn more about the that influence in-channel consumer behaviors and decisions.

It should be recognized that data collected by a system 15 does not have to be limited to “clicks” of a mouse or keystrokes, and the like. It is contemplated that a panelist might be provided with blood pressure or heart monitoring devices, an eye tracking device, video camera or any other type of device that might provide a researcher 21 with additional detail regarding a consumer's shopping habits such as how excited a person becomes while demonstrating a new product.

To facilitate analysis of the collected data in a research module, a researcher 21 might be provided with access to the research module 18. In particular, a researcher 21 may be provided with research instruments that allow a researcher to facilitate the analysis of data collected through panelist's interactions with the system 15. As used herein, the term facilitate is contemplated to mean that the system might be configured to allow collected data to be filtered, separated, organized, parsed, or decoded such that a researcher might be capable of analyzing the data. These research instruments might be in the form of software, executable instructions or the like. For example, a researcher 21 may specifically generate a virtual purchase environment to facilitate the testing of an introduction of a new product such as a laundry detergent. After allowing a plurality of panelists to conduct shopping exercises, a researcher 21 may apply various research instruments to find that panelists 20 that read a particular label are less likely to purchase the product. Based on this data, a researcher 21 might have the programming tools to reprogram the label design on the virtual product and re-test the product's acceptance among panelists.

A researcher 21 as contemplated in FIG. 1 and described throughout the invention is contemplated as a person or group of persons seeking to learn more about the factors that influence in-channel consumer behaviors and decisions. In one embodiment of the invention, a researcher 21 may work for or provide consulting to a consumer product manufacturing company. It should be recognized that a researcher's capabilities with respect to a virtual in-channel marketing and product testing system 15 might be significantly enhanced versus traditional methods. An equivalent traditional brick-and-mortar approach to test marketing a product might typically require a researcher 21 to establish a central physical location and physically create an actual test store. One of the drawbacks associated with this approach is the time consuming nature of creating and re-creating an actual, physical test environment. It should be recognized as an advantage of the present invention that providing an in-channel marketing and product testing system 15 in a virtual environment, such as over the Internet, should allow for dynamic manipulation by a researcher 21 of a virtual purchase environment 27, such as real-time manipulation. In other words, a researcher 21 might be capable of changing any identifiable characteristic of any product, or any other characteristic of a virtual purchase environment 27, by simply programming the desired changes. It should be understood that depending on the nature of the desired manipulates it may take anywhere from several minutes to at most several hours to program or re-program the manipulations to a holistic virtual purchase environment 27.

Additionally, it should be recognized that an in-channel marketing and product testing system 15 should be capable of being easily duplicated and interconnected. In a non-limiting embodiment of the invention, a researcher 21 could program a plurality of distinct virtual purchase environments 27 to allow parallel testing of consumer products with the system 15. In particular, a system 15 might allow for simultaneous testing of a different versions of a product in a predetermined virtual purchase environment, or, might allow testing of different versions of a product over a period of time. For example, if a consumer product manufacturer contemplates bring a new laundry detergent to market and has three concept packaging designs to choose from, the researcher could program three distinct virtual purchase environments 27 each comprising a concept design to analyze consumer acceptance of that particular design. Other examples may include testing a change in product sales a based on exposure to an in-store advertisement or an in-store coupon. The tests could be accomplished simultaneously, or, over a predetermined time period. Additionally, it should be recognized that due to the virtual nature of the system, an actual product does not have to be in existence, rather, a realistic virtual product could be computer designed and generated. In such a scenario, panelists would be limited to pretend purchasing.

FIG. 3. depicts a more detailed, exemplary embodiment of the present invention. In this embodiment, it is contemplated that an in-channel product testing system 15 may be further provided with a data store 22 for storing data associated with the system 15. It should be recognized a data store 22, could comprise multiple data stores in multiple locations, and that data stores could be provided with backup data stores to ensure the system 15 is operable at any time and from any location. It should also be recognized that a data store 22 could be could be in selective communication with any component of a system 15.

In a non-limiting embodiment of the invention, a data store 22 might be provided with data comprising at least one predetermined virtual purchase environment 27 such as an actual, physical shopping facility or fictitious shopping facility that is pre-programmed and stored as data in a data store 22. In other words, it is contemplated that a researcher may be in selective communication with a data store 22 and a purchase environment module 17, such that the researcher 21 might be capable of downloading a predetermined virtual purchase environment from the data store 22 to a virtual environment module 17 for display to a consumer panelist 20. As used herein, the term download is contemplated to mean that data from a data store 22 is configured to be transmitted to any component of a system 15 such as a purchase environment module 17.

In one embodiment of the invention, a data store 22 might be in selective communication with a research module 18 or directly with a panelist's interface 19, to collect the “clicks” of a mouse or other input that a panelist 20 uses to interface with a system 15. It is contemplated that if a data store 22 is in communication with a research module 18, the data collected in the research module might be capable of being downloaded from the research module to the data store and vice versa. In an exemplary embodiment of the invention, a data store 22 might store the “clicks” or other panelist input and provide selective access to the data to a researcher 21 to aid the researcher in learning more about the factors that influence in-channel consumer behaviors and decisions. The data from the data store 22 should be accessible by a researcher at any time.

Additionally, it is contemplated that a data store 22 might be configured to store other information inputted into a system 15 by a consumer panelist 20 through a panelist interface 19. For example, as will be further described, a consumer panelists 20 might be asked to input personal information such as geographic information, income range, current product preferences, family information and the like. Moreover, a researcher 21 may be capable of communicating with and/or asking questions to a potential consumer panelist either before, during or after a shopping exercise. These questions and answers may be input that is stored in a data store 22. Additionally, panelists previous interactions with a system 15 such a previous purchases might also be downloaded and stored in a data store 22.

As depicted in FIG. 3, it is contemplated that a system 15 may further comprise a fulfillment module 24. Although a fulfillment module 24 could be in communication with any component of a system 15, in an exemplary embodiment of the invention, a fulfillment module 24 might be in selective communication with a purchase environment module 17. A fulfillment module 24 might be capable of processing panelist purchase orders, or, in other words, allowing a consumer panelist 20 to actually purchase any product selected during a shopping exercise. It should be recognized that a virtual shopping exercise can be conducted without providing actual fulfillment of a panelist's selected products. For example, a shopping exercise could be conducted wherein a panelist is simply asked which product the panelist would purchase under certain circumstances, or the shopping exercise could terminate once a panelist “pretend” purchases a particular product. In other words, it is contemplated that the system 15 might allow an actual purchase wherein the particular product is shipped to the panelist, or a pretend purchase wherein after the session is terminated the product is not shipped to the panelist. This feature might be particularly useful if a manufacturer is testing multiple concept designs and the actual product is not yet in existence. However, in an exemplary embodiment of the invention, a fulfillment module is provided to afford a more holistic shopping environment to a consumer panelist 20. It should also be recognized that a fulfillment module 24 may allow a panelist to purchase a product in any currency and should be capable of fulfilling product delivery anywhere in the world. A fulfillment module 24 could be provided in the form of a software package that is commonly available in the industry.

As further illustrated in FIG. 3, it is contemplated that a system 15 might also comprise an inventory module 25 and delivery module 26. Once again, either of these modules could be separate or integral components of a system 15, or could be in communication with any component of a system 15, but in an exemplary embodiment of the invention both modules are in selective communication with a fulfillment module 24. An inventory module 25 might allow for inventory tracking and maintenance and might also be provided with instructions that allow a system 15 to display empty shelf space where actual product is out of stock, if it is contemplated that actual product will be shipped to the panelist. A delivery module 26 might be provided with instructions relating to tracking shipments and ensuring ordered products reach their destination. A delivery module 26 might also be in communication with a panelist interface 19, to allow a panelist to track the status of ordered products. It should be understood that these modules are currently available in the form of software and are widely available in the industry.

In another embodiment of the invention, it is contemplated that panelists might have access to a portal module 28, which might be in selective communication with a purchase environment module 17 or any other component of a system 15. A portal module 28 is contemplated as providing panelists access to interactive chat-rooms, bulletin boards, e-mail systems, messaging systems and a variety of Internet links. Moreover, a portal module 28 might allow a panelist to access a home management system such as Audrey or Family Helper, which might contain a panelists shopping list or other relevant information. Again, these various options can be currently provided in the form of software commonly available in the industry.

It is further contemplated that an in-channel product testing system 15 might be configured to allow for system supervision, maintenance, upgrades and general monitoring of the system 15 by a system administrator. In a non-limiting embodiment of the invention, it is contemplated that a researcher 21 might assume the responsibilities of a system administrator. While a system administrator could be located on site with a system server in some applications, a system administrator might have the ability to access the components of a system 15 from remote locations. More importantly, it is contemplated that a system administrator have ready access to any component of the system 15 at any time.

It should be understood that in an exemplary embodiment of the invention, the in-channel product testing system 15 is contemplated to be research driven. That is, the purpose of the system 15 is not to provide an e-tailing store, but, rather, to facilitate research relating to factors that may influence in-channel consumer behaviors and decisions such as whether a consumer might purchase or repurchase a particular product. In other words, the system 15 might be configured to allow, for example, a consumer panelist to pretend purchase a product or to actually purchase a product and have it shipped to the panelist. However, the underlying purpose of allowing a panelist to shop within a virtual purchase environment is to allow a consumer product manufacturing company to maximize the effectiveness of introducing a new product to market.

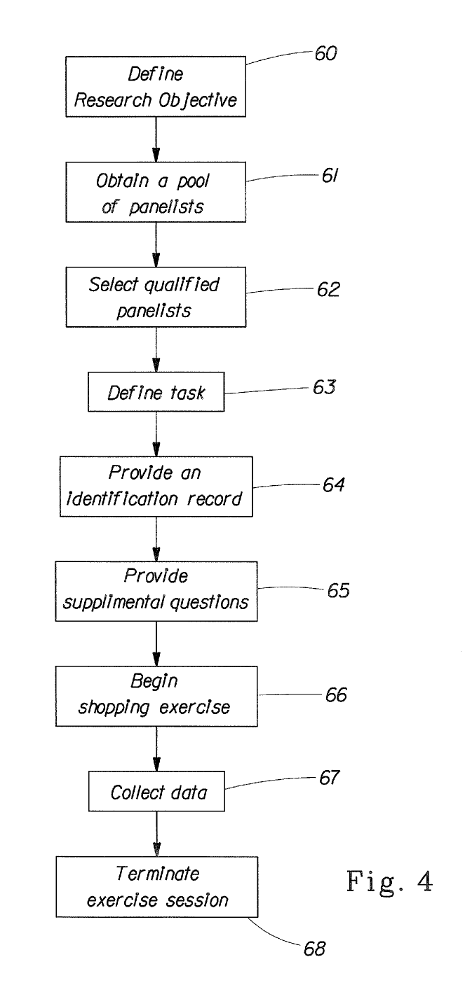

An exemplary embodiment of a method of using an in-channel marketing and product testing system, such as that relating to test marketing a consumer product, is illustrated in FIG. 4. It is contemplated, that a researcher might first define a particular research objective 60, such as, for example, measuring the impact of exposure to an in-store advertisement on product sales, or, alternatively, measuring the elasticity of demand of a product based on a change in price due to an offering of an in-store coupon. It should be recognized that these are only two examples of a nearly unlimited variety of objectives definable by a researcher 21.

Next, after a researcher has defined a particular research objective, a pool of panelists 61 willing to participate in an interactive shopping exercise relating to the particular research objective 60 might be obtained. In an exemplary embodiment of the invention, a pool of consumer panelists 61 might be obtained through advertising on an Internet portal such as America Online, Yahoo, or other highly visible web-site. Also, a pool of consumer panelists 61 could be obtained through more traditional approaches such as through a research supplier such as National Family Opinion (NFO) or through an in-house internal control panelist list. In either case, potential consumer panelists 20 that volunteer to participate in an interactive shopping exercise may be required to complete a survey comprising a plurality of introductory questions relating to products they currently use, where they live, income range, general family information, and the like. The survey might be capable of being completed on-line, or might be submitted through traditional approaches.

A researcher 21 might next select a limited number of qualified panelists 62 from a pool of panelists 61 to participate in a shopping exercise that might allow a researcher 21 to test factors that influence in-channel consumer behaviors and decisions. For example, based on a researcher's defined objective 60, a researcher 21 may screen surveys completed by potential panelists within the pool of panelists 61. In more detail, if a manufacturer intends to introduce a new brand of baby diaper, the researcher may, at a minimum, require potential panelists to have children of diaper wearing age in the household. Other examples may include, but are not limited to screening-out male candidates for analysis of feminine hygiene products or screening non-soda drinkers to test the market acceptance of a re-invented brand of soda. In addition, a researcher may also screen survey's based on the occupation of the potential panelist, the potential panelist's employer, or any other type of information. For example, a consumer product manufacturing company may not want employees of a competitor to preview a potential new product. It should be recognized that the above examples are only a small portion of the numerous applications of the present invention.

Next, a researcher 21 might devise a specific task 63 for the selected panelists to accomplish. It should be recognized that a specific task 63 might relate to a particular research objective and could take any variety of forms. In an exemplary embodiment of the invention, a specific task 63 might be measurable by a panelist's input such as “clicks” of a mouse or the like. In one example, if a researcher 21 desires to test the likelihood of consumer acceptance of a new product such as a laundry detergent, the identified task may be requiring the selected panelists 20 to purchase laundry detergent while participating in a shopping exercise. In completing the task, a consumer may “click-on” any number of different detergents to read labels, or comparison shop before selecting or purchasing a particular product. A researcher 21 might then analyze the collected data or “clicks” and compare which products were viewed and which products were actually purchased.

After a researcher 21 defines a specific task 63, it is contemplated that the selected panelists 20 might be contacted by a researcher 21 through e-mail or any other method of communication. In an exemplary embodiment of the invention, a researcher 21 may provide each selected panelist with an identification record 64 such as a username and password that would allow the panelist 20 to access the system 15. In an alternative embodiment, an identification record 64 could be embedded in a URL transmitted to a panelist. It is contemplated that by providing a panelist an identification record 64, a panelist could access the system 15 at any time that is convenient for the panelist 20. Moreover, a panelist could participate in any shopping exercise from any computer connected to the Internet such as through a home computer, or, if time permitted, through a computer located at work. It should also be recognized that an identification record 64 might allow a panelist to access the system 15 at any time for a predetermined period of time, or, might simply allow a panelist to access the system 15 once. Thus, a panelist could be provided with one-time access to a system 15 to complete a particular task, or a panelist could be allowed unlimited entry into a system 15 for a predetermined period of time and to complete multiple tasks.

It is further contemplated that a researcher 21 may provide at least one question 65 to a selected panelist 20 relating to a particular research objective or a particular task. It should be recognized that questions 65 asked to a panelist could be communicated to the panelist in an number of ways such as through e-mail, text messaging, survey engines and the like. In addition to providing a plurality of introductory questions to a panelist when a panelist volunteers to participate in an interactive shopping exercise, it is further contemplated that once a panelist is selected from a pool of panelists 61 to participate in a shopping exercise, a researcher 21 may provide a panelist with additional and more specific questions to further provide the researcher with data relating to shopping habits of the particular panelist. In a non-limiting embodiment of the invention, a plurality of questions could be pre-programmed in a system 15 and displayed to the panelist upon the panelist logging into the system 15. A program, such as a survey engines, may be used to implement this embodiment, and may also be provided with other features such as skip patterns and the like.

Additionally, it should be recognized that questions 65 could be provided to a panelist 20 at any point of a shopping exercise. For example, although questions could be provided prior to commencement of a shopping exercise, questions could also be provided following termination of a shopping exercise, or, could alternatively be interactively provided during the course of a shopping exercise. Moreover, it is contemplated that because a system 15 is capable of collecting data in real-time, questions could be tailored based on a panelists activity in a virtual purchase environment. Examples of follow up questions may include but are not limited to, why a panelist selected or purchased a particular product or whether an advertisement or coupon impacted a purchase decision. Examples of questions provided interactively during the course of a shopping exercise may include but are not limited to, why a panelist choose to read a particular label or what characteristics of a product are liked or disliked by the panelist.

It is further contemplated that answers provided by a panelist to at least one question could be used to define at least a portion of a virtual purchase environment 27. In other words, a virtual purchase environment 27 could be generated, based at least in part on an answer to a question provided by a panelist 20 or by any other panelist input. For example, a panelist 20 may be provided with a series of questions relating to laundry detergents. Based on the answers to those questions, a researcher 21 may program a virtual purchase environment 27 to incorporate input provided by the panelist.

Additionally, a researcher 21 may provide a panelist with a shopping stimulus. For example, prior to beginning a shopping exercise, a panelist may be provided with an in-store coupon or exposure to an advertisement or banner to test whether such a stimulus might have an impact on consumer behavior and decision making while participating in a shopping exercise. It should be recognized that shopping stimuli would not be limited to being present prior to beginning a shopping exercise, but, could also be presented or offered while a panelist is undertaking interaction with a system 15. For example, while participating in a shopping exercise, banner advertisements might be displayed, a virtual coupon book could be offered or a product could be demonstrated at a demonstration station.

After selecting qualified panelists and assigning each panelist an identification record 64, a panelist 21 might then begin a shopping exercise 66 as further contemplated in FIG. 4. In an exemplary embodiment, a panelist 21 might access a system 15 through any computer having an Internet connection. Upon accessing an appropriate web-page, a panelist might be asked to “log on” to the system 15. For example, at an appropriate “log on” screen, a panelist may input desired identification, such as a user name and password, which a panelist interface 19 might compare against information stored in a system data store 22. If a match is found, the system 15 might display an introductory screen having a message such as “you are being asked to go on a shopping trip. Feel free to explore any area of the store, as you would in an actual shopping trip. While shopping you are to look for and purchase laundry detergent.” It should be recognized that an introductory screen may comprise any type of welcome information and text, but should at least include a description of a task the panelist is to carry out.

After carefully reviewing an introductory screen and choosing an appropriate continuation icon, a system 15 might generate a virtual purchase environment 27 which might display a front facing of an actual or fictitious store. It is contemplated that a front facing of a store might display a variety of holistic elements such as an entryway through a front door, a display of shopping carts, check out counters and the like. It should be recognized that a front facing of a store could be modified or could be pre-programmed to simulate any actual, existing, or fictitious store front. It should also be recognized that a system 15 could be programmed to allow a panelist 20 to start at any selected point within a virtual purchase environment 27, but in an exemplary embodiment of the invention, a shopping exercise is configured to begin at the same point every time, such as a display of a front facing of a store.

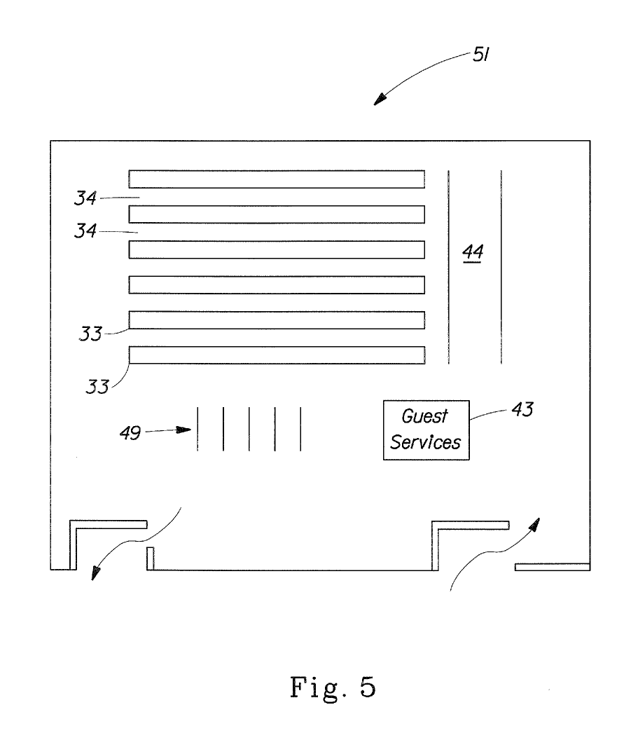

In an exemplary embodiment of the present invention, a virtual purchase environment 27 comprises a fictitious store. FIG. 5 depicts a screen shot of a store layout or store map 51 as contemplated by the present invention. While it should be recognized that a virtual purchase environment 27 could have any number of aisles 34, in an exemplary embodiment of the invention, a virtual purchase environment comprises at least one aisle 34, having a plurality of shelves 33 and displaying a plurality of competitive products 31. Moreover, a virtual purchase environment 27 might also display a plurality of checkout aisles 49 and a guest services center or help area 43. Upon a panelist 20 virtually moving to the check out aisles 49, or clicking on “check out” at any point in a shopping exercise, a consumer panelist 20 is allowed to check-out, and in some circumstances, as previously described, actually purchase the products 31 selected. Upon virtually moving to a guest services 43 area, or “clicking” on guest services or other related icon at any point in a shopping exercise, a panelist 20 might be displayed a help desk, and provided with a plurality of icons for the panelist 20 to click such as store map, site tour, frequently asked questions, contact us, or any other type of related icon. Additionally, a guest services center 43 may also provide live help such as through text messaging, or any other method of communication. It should be understood, that the features of any virtual purchase environment could be configured with a any combination of icons and any variety of store layout and configuration. Moreover, it should be recognized that in any virtually generated environment, the names of the icons could vary and the icons might be configured to be enabled or disabled depending on the desire of a researcher 21.

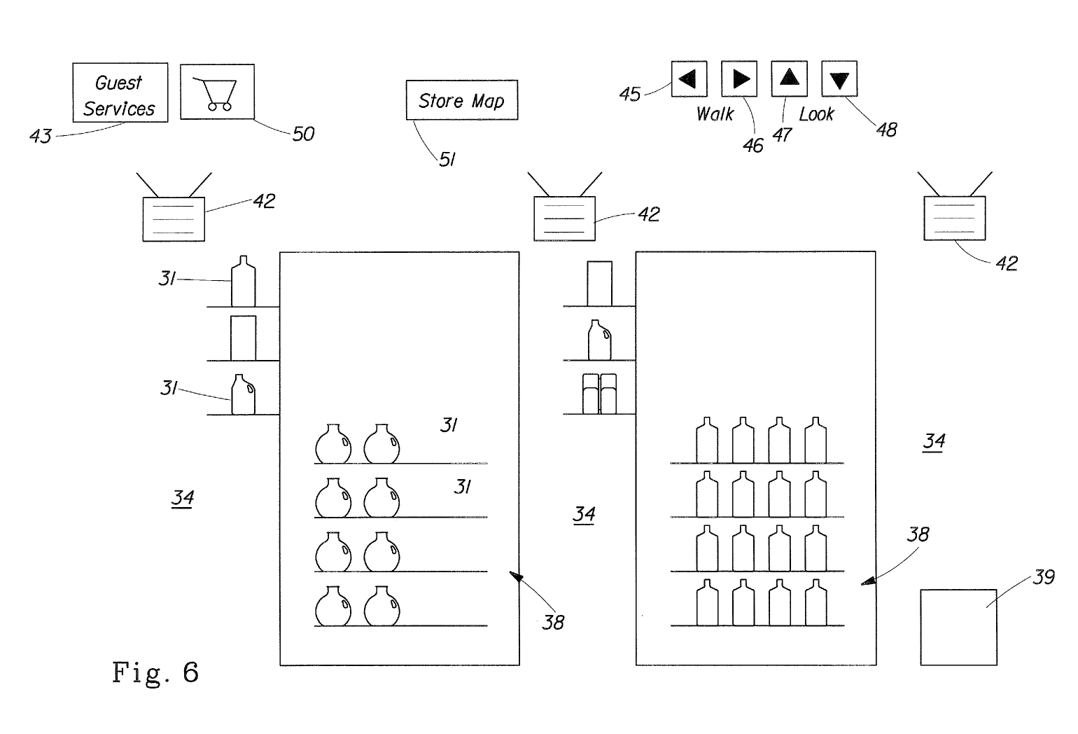

As illustrated in FIG. 6, an exemplary embodiment of the invention, it is contemplated that upon virtually entering a store through a displayed store front, a consumer panelist 20 might be situated in a main aisle 44 (see FIG. 5) viewing a plurality of end-cap displays 38, virtual aisles 34 and perhaps even a demonstration station 40. A panelist 20 might have the option of walking left 45 or right 46, by “clicking” the appropriate icons, through a main aisle 44 to determine which product categories are located down each aisle 34 as may be illustrated on signs 42, or, choosing to look up 47 or down 48 a particular aisle 34 to view products 31 stocked on shelves 33 within an aisle 34. It is contemplated that movement within a virtual purchase environment 27 could be accomplished any number of ways including arrow icons 45, 46, 47, & 48, or through other input devices such as a joystick or keys on a keyboard. It is further contemplated that a virtual purchase environment 27 might display whether a product 31 is out of stock, or, might display damaged products, products in disarray simulating they have been picked over, or any other type of holistic virtual environment. Furthermore, at any point in a shopping exercise, a panelist might have the opportunity to check out 43, view items in a shopping cart 50, or view a store map 51, by “clicking” the appropriate icon.

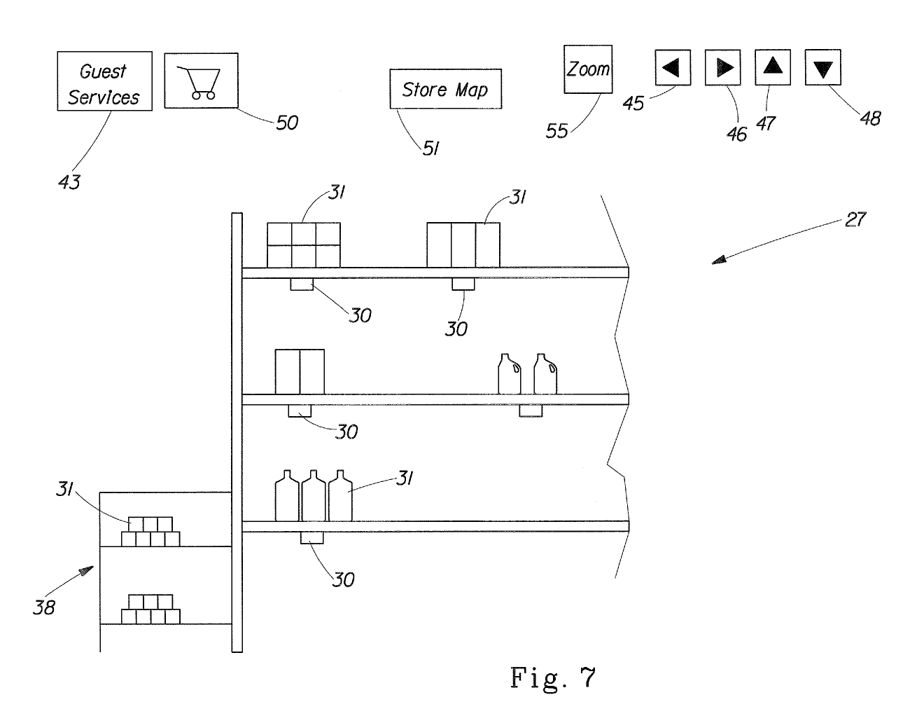

In an exemplary embodiment of the invention, once a panelist selects an aisle 34 to walk down, a system 15 displays a side view of an aisle as depicted in FIG. 7. A side view may be provided with a zoom option 55 icon that allows a panelist to zoom-in or zoom-out of a view of shelves 33, thereby allowing a panelist to get an overview of products 31 located in an aisle 34 or get a close up of a particular product category on a particular shelf 33. A side view is also contemplated to be provided with a guest services 43 icon, view cart 50 icon, store map 51 icon and walk and look icon's 46, 47, 48, and 49. In an exemplary embodiment of the invention, a side view shows three-dimensional views of products 31 as they might be displayed in an actual store. For example, an aisle comprising laundry detergents may depict boxes of Tide, FAB, Surf, Cheer and any other brand and size of laundry detergent, in a side-by-side depiction, as would be seen in an actual store. In such a scenario, a laundry detergent aisle may comprise as little as 70 stock keeping units (sku's) versus an aisle such as the hair care aisle which may comprise about 600 sku's.

It is further contemplated that information 30 regarding products 31 might be displayed below a product 31 on a shelf 33 such as the name of a product, its price and a price per unit, to facilitate comparison shopping. In an alternate embodiment, a price of a product may be displayed on a shelf, but as a panelist moves a “mouse” over a screen on a panelist interface 19, and stops on a particular product, a “mouse over” might similarly display the same information. In this way a panelist can comparison shop in the context of a holistic environment.

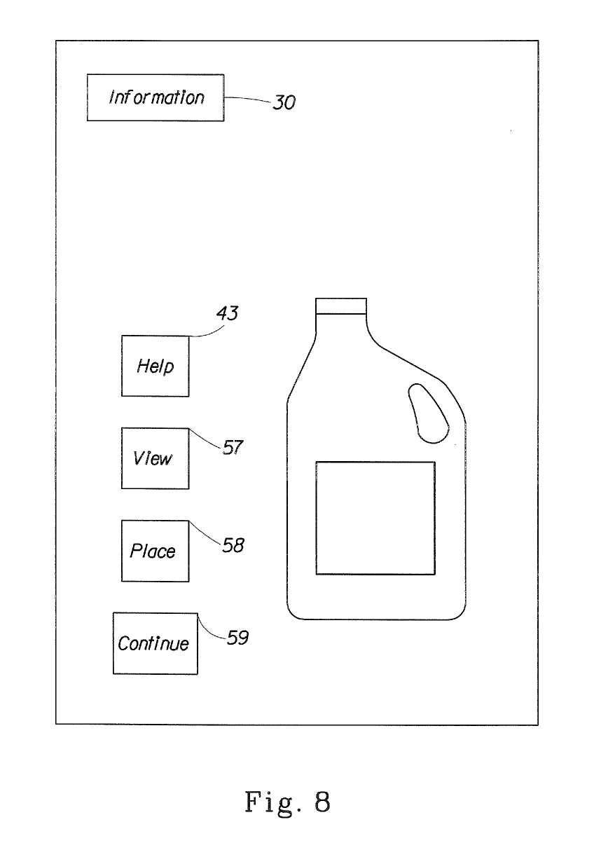

Additionally, in an exemplary embodiment of the invention, if a panelist “clicks” on a particular product 31, a close-up of the product may be displayed, as illustrated in FIG. 8. As FIG. 8 illustrates, an individual product might be virtually displayed as an almost exact replica of an actual store product. It is further contemplated that a view 57 icon might be provided to provide a panelist 20 with an opportunity to view and read any labels associated with a product. By clicking a view icon 57, a system 15 might allow a panelist to view all angles and sides of a particular product 31. Additionally, at this screen, a panelist might be presented with a plurality of other icons allowing a panelist 20 to place 58 an item in a cart, continue shopping 59, or get help 43. Once a panelist finishes browsing or shopping in an aisle, a panelist might exit an aisle 34 to a main aisle 44, to continue shopping. At this point, a panelist has the option to continue shopping by virtually moving about a virtual store by using the appropriate icons, including having options to go to guest services 43 or check out 49. Once again, it should be understood that the descriptions, icons, store map and any other feature of a purchase environment could be rearranged and configured with a any combination of desired features and that the invention is not limited to any of the above described features. Rather, the above exemplary embodiments are representative of the capabilities of the system.

As further depicted in FIG. 4, after a shopping exercise has commenced 66, a panelists interactions within a virtual purchase environment 27 might be collected 67 as data so that a researcher 21, upon analysis, can learn more about the shopping habits of consumers when purchasing consumer products. Although, it is contemplated that a research module 18 might be configured to receive panelist input from a panelist interface 19 to facilitate analysis of the collected data, any component of a system 15 could be configured to receive the panelist's input, such as, for example, a data store 22.

It should be recognized that data, or panelist input, such as “clicks” of a mouse can be captured in real-time for immediate analysis by a researcher 21. A researcher 21 may use collected data, or panelist input, for a number of purposes, most notably, to predict the acceptance rate of a product being introduced to market. A researcher 21 may base such analysis on collected “clicks” or other panelist input such as panelist purchases, panelists views of a particular product, answers to questions posed before, during or following a shopping exercise, psychological or other types of prediction models.

Finally, it is contemplated that a panelist 20 might be able to shop for as long a period as desired, but when a panelist checks out after completing a defined task 63, the shopping session is terminated 68. It should be recognized that a panelist's identification record 64 might be programmed such that a panelist might be limited to a single shopping exercise, or might be allowed access to a system 15 over a predetermined period of time to achieve one or more assigned tasks. The panelists could be allowed an open shopping experience and allowed to purchase multiple items, or could be limited to purchasing a particular item. Moreover, a panelists shopping exercise could include either actual or pretend purchasing, or a combination of both, based simply on a researcher's particular objective.

It also should be recognized that during or following the collection and analysis of data, or panelist input, a researcher 21 may re-program and change an identifiable characteristic of a product such as price, packaging, location of a product on a store shelf or arrangement within an aisle. A researcher may run multiple tests on a product having differing characteristics to determine which combination of factors allows the greatest chance of success in selling a particular product. Moreover, a researcher may allow the same panelists or different panelists to participate in a particular shopping exercise or to participate in multiple shopping exercises. In any event, it should be recognized that the purpose of a system 15 is to facilitate testing of factors that influence in-channel consumer behaviors and decisions, and to provide consumer product manufacturers with information that allows the company to make better decisions in bringing new products to market.

In more advanced applications of the system 15, it is foreseeable that external data sources might be combined with data collected in a research module to facilitate more advanced studies. For example, data could be collected in a real world setting and combined with data from the research module. In particular, a researcher might be capable of collecting real-world transactions, such as purchasing consumer information from a credit card company or other card company, and either combining it with data collected from the virtual purchase environment, or correlating it with the data to ensure its accuracy. Other data sources may include information obtained through Internet sales, direct marketing sales, telephone sales and the like.

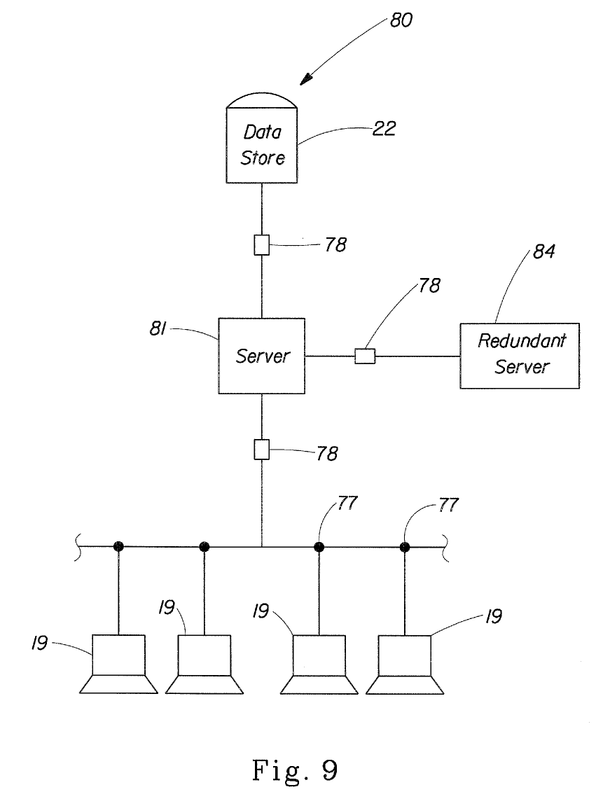

FIG. 9 depicts a sample network system 80 which might be employed to implement an embodiment of the present invention. In particular, a network system 80 might comprise a server 81, such as available from Dell, Hewlett-Packard, Sun Microsystems, IBM, or any other number of manufacturers. A server 81 might comprise a set of executable instructions, such as in the form of software, routines, programs, algorithms, code and the like for generation of a virtual purchase environment and for collecting data, or panelist's input while a panelist is interacting with the system 15. Moreover, a server 81 might comprise a plurality of software module applications such as instructions for a fulfillment module 24, inventory module 25, delivery module 26, portal module 28 or any other desired software applications. These applications may be available from providers such as Sun Microsystems, Microsoft Corporation and a variety of other companies. Additionally, it is contemplated the applications may be compatible with a variety of operating systems such as NT, Linux, Unix, OS/2 and the like.

A network system 80 may further comprise a redundant server 84 to accommodate diversity in customer base as well as provide a real-time back-up should either server 81, 84 fail. Moreover, a network system 80 may further comprise as either a separate or integrated a data store 22 which might be a database such as Oracle® 8i. Additionally, it should be recognized that the servers 81, 84 and/or data store 22 could be provided with firewalls 78 to protect a system 15 from unauthorized use.

A system server 81 may be in communication with a plurality of nodes 77, such that each node 77 can send and receive information to the system server 81. As further illustrated in FIG. 9, each node 77 is connected with a panelist interface 19 such as a personal computer. It is contemplated that each node 77 is connected to a system server 81 such as via a token ring, Ethernet, telephone modem connection, radio or microwave connection, parallel cables, serial cables, telephone lines, USB, Firewire, Bluetooth, fiber optics, IR, RF and the like, or combinations thereof.

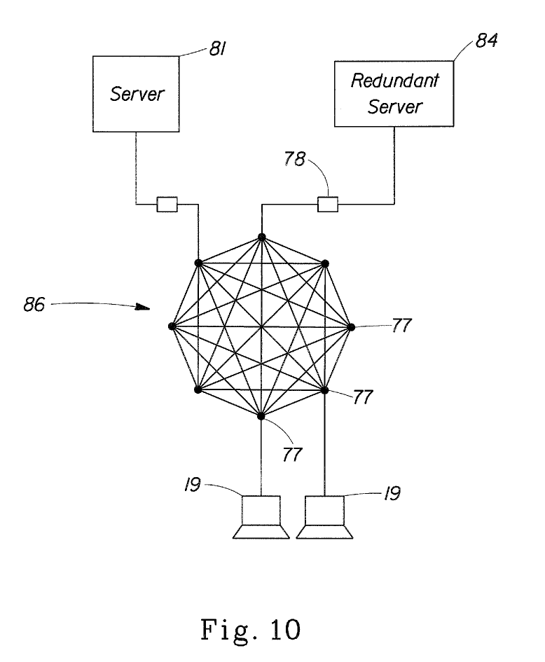

In an alternate embodiment of the present invention as illustrated in FIG. 10, it is contemplated that each node 77 or each component of a system 15 could be located anywhere in the world that is in communication with the Internet 86. The Internet 86 is comprised of numerous webs of connections that cover the entire world allowing a user or panelist to interact with the interactive system through a panelist interface 19 such as a computer, as long as the panelist interface is connected to the Internet. A panelist interface 19 might be a desktop computer such as available from IBM, Dell, Gateway, Apple, and a variety of other manufacturers. The computer may comprise a modem for a dial-up connection to a local Internet service provider, or may connect to the Internet 86 through an xDSL line or a cable modem.

Still other advantages and novel features of the present invention will become apparent to those skilled in the art from the following detailed description, which simply illustrates various modes contemplated for carrying out the invention. As will be realized, the invention is capable of other different obvious aspects, all without departing from the invention. Accordingly, the drawings and descriptions are illustrative in nature and not restrictive.

What is claimed is:

1. A method of obtaining eye tracking data from a panelist comprising the steps:
(a) displaying a virtual image of a product to the panelist via a panelist interface, wherein the panelist interface comprises an Internet connection, wherein said virtual image is received by the panelist interface via the Internet;
(b) collecting eye tracking data by eye tracking the panelist with an eye tracking device while displaying said virtual image of the product; and
(c) obtaining the collected eye tracking data from the panelist via the Internet.

2. The method of claim 1, wherein the panelist interface is chosen from computer, personal digital assistant, cell phone, automobile computer, interactive television, or Internet appliance.

3. The method of claim 2, wherein the panelist interface is a cell phone.

4. The method of claim 2, wherein the panelist interface is an interactive television.

5. The method of claim 1, wherein:
(a) the virtual image of the product further comprises an identifiable characteristic of the product,
wherein the identifiable characteristic is chosen from: packaging of the product; location of the product on a store shelf, arrangement of the product with respect to other products, or combinations thereof; and
(b) the step of eye tracking the panelist further comprises eye tracking the panelist with respect to the identifiable characteristic of the product to obtain eye tracking data.

6. The method of claim 5, wherein the panelist interface is a cell phone.

7. The method of claim 5, wherein the panelist interface is an interactive television.

8. A method of obtaining eye tracking data from a panelist comprising the steps:
(a) offering a reward to the panelist via a panelist interface for participating in data collection;
(b) displaying a virtual image of a product to the panelist via the panelist interface, wherein the panelist interface comprises an Internet connection, wherein said virtual image is received by the panelist interface via Internet;
(c) collecting eye tracking data by eye tracking the panelist with an eye tracking device while displaying said virtual image of the product;
(d) obtaining the collected eye tracking data from the panelist via the Internet; and
(e) providing the reward to the panelist via the panelist interface for participating in data collection.

9. The method of claim 8, wherein the panelist interface is chosen from computer, personal digital assistant, cell phone, automobile computer, interactive television, internet appliance.

10. The method of claim 8, wherein:
(a) the virtual image of the product further comprises an identifiable characteristic of the product,
wherein the identifiable characteristic is chosen from: packaging of the product; location of the product on a store shelf, arrangement of the product with respect to other products, or combinations thereof;
(b) the step of eye tracking the panelist further comprises eye tracking the panelist with respect to the identifiable characteristic of the product to obtain eye tracking data.

11. The method of claim 10, wherein the panelist interface is a cell phone.

12. The method of claim 10, wherein the panelist interface is an interactive television.

13. The method of claim 12, wherein the reward is chosen from free merchandise or coupon.

14. A method of obtaining eye tracking data from a panelist comprising the steps:
(a) displaying a virtual shopping environment to the panelist via a panelist interface,
wherein the panelist interface comprises an Internet connection;
wherein the virtual shopping environment is received by the panelist interface via the Internet;
wherein the virtual shopping environment comprises a plurality of virtual products;
(b) instructing the shopper via the panelist interface to virtually purchase at least one product, of the plurality of virtual products, in the virtual shopping environment;
(c) collecting eye tracking data by eye tracking the panelist with an eye tracking device while displaying said virtual shopping environment;
(d) obtaining the collected eye tracking data from the panelist via the Internet.

15. The method of claim 14, wherein the panelist interface comprises an interactive television.

16. The method of claim 14, wherein the panelist interface comprises a personal computer.

17. The method of claim 14, wherein at least one product, of the plurality of virtual products comprises a prototype product.
